(19) United States
(12) Patent Application Publication
(10) Pub. No.: US 2020/0026848 A1
(43) Pub. Date: Jan. 23, 2020

(54) INFORMATION PROCESSING APPARATUS AND INFORMATION PROCESSING METHOD

(71) Applicant: MITSUBISHI ELECTRIC CORPORATION, Tokyo (JP)

(72) Inventors: Tomohiko UKITA, Tokyo (JP); Gen TAKEYAMA, Hyogo (JP); Tetsuhiro KOHADA, Tokyo (JP); Tetsuji FUJISAKI, Tokyo (JP)

(73) Assignee: Mitsubishi Electric Corporation, Tokyo (JP)

(21) Appl. No.: 16/338,334

(22) PCT Filed: Nov. 30, 2016
(86) PCT No.: PCT/JP2016/085461

§ 371 Date: Mar. 29, 2019

(51) Int. Cl. G06F 21/46; G06F 21/60

(52) U.S. Cl. CPC G06F 21/46; G06F 21/60

(57) ABSTRACT

A storage of an information processing apparatus stores data, and stores a password when the password has been set. If an entered password matches the password stored in the storage, an individual PW writer of a PW management unit of a controller performs at least one of data reading processing and data writing processing on the storage. The attachment state determination unit determines whether or not the information processing apparatus has been attached to an attachment target. In the case where the attachment state determination unit determines that the information processing apparatus has been attached to the attachment target, if the password is stored in the storage, the controller changes the password stored in the storage, and if the password is not stored in the storage, the controller stores and sets a new password in the storage.

### TECHNICAL FIELD

The present invention relates to an information processing apparatus and an information processing method.

### BACKGROUND ART

In information processing apparatuses, there are cases where a password is set in a storage such as a hard disk device in order to prevent data stored in the storage from leaking to the outside.

For example, a vehicle control device disclosed in Patent Document 1 includes control information storage means for storing control information for use in controlling the operations of a vehicle-mounted system, password storage means for storing a preset password, and control information write-enabling means for enabling the writing of control information to the control information storage means if an entered password matches the password stored in the password storage means.

### PRIOR ART DOCUMENTS

### Patent Documents

Patent Document 1: Japanese Patent Application Laid-Open No. 2015-178323

### SUMMARY

### Problem to be Solved by the Invention

In consideration of convenience in updating data in manufacturing lines and oversea warehouses, it is desirable either not to set any passwords in the storages of information processing apparatuses or to share a common password among a plurality of products. However, there is a risk of product information leakage in the market if no passwords are set in the storages. Even if passwords are set in the storages, a common password shared among a plurality of products still has a risk of information leakage from all products if the password stored in the storage of one information processing apparatus is cracked in the market.

In the aforementioned vehicle control device disclosed in Patent Document 1, in order to prevent password leakage from affecting other supply destinations, the password storage means includes a password writing unit to which a plurality of passwords set for each vehicle supply destination is written, and a valid password information writing unit to which information for making all those passwords invalid, except for one password, is written.

The vehicle control device disclosed in Patent Document 1, however, uses one of a limited number of a plurality of passwords as a valid password, so there is the possibility that a plurality of vehicle control devices may use the same password as their invalid password. If that invalid password is cracked, information can leak from a large number of vehicle control devices.

It is an object of the present invention to provide an information processing apparatus and an information processing method that offer a high degree of security robustness.

### Means to Solve the Problem

An information processing apparatus according to the present invention includes a storage that stores data and stores a password when the password has been set, a controller that, when the password has been set and if an entered password matches the password stored in the storage, performs at least one of processing for reading the data and processing for writing the data on the storage, and an attachment state determination unit that determines whether or not the information processing apparatus has been attached to an attachment target. In the case where the attachment state determination unit determines that the information processing apparatus has been attached to the attachment target, if the password is stored in the storage, the controller changes the password stored in the storage, and if the password is not stored in the storage, the controller stores and sets a new password in the storage.

An information processing method according to the present invention includes storing data in a storage, storing a password in the storage when the password has been set, performing at least one of processing for reading the data and processing for writing the data on the storage if an entered password matches the password stored in the storage, determining whether or not an information processing apparatus including the storage has been attached to an attachment target, and in the case where it is determined that the information processing apparatus has been attached to the attachment target, changing the password stored in the storage if the password is stored in the storage, and storing and setting a new password in the storage if the password is not stored in the storage.

### Effects of the Invention

According to the information processing apparatus of the present invention, the information processing apparatus is constituted by the storage, the controller, and the attachment state determination unit. The storage stores data. When a password has been set, the storage stores the password. If the entered password matches the password stored in the storage, the controller performs at least one of processing for reading the data and processing for writing the data on the storage. The attachment state determination unit determines whether or not the information processing apparatus has been attached to an attachment target. In the case where the attachment state determination unit determines that the information processing apparatus has been attached to the attachment target, if the password is stored in the storage, the controller changes the password stored in the storage. If the password is not stored in the storage, the controller stores and sets a new password in the storage. Accordingly, it is possible to either set another password different from the password before attachment or set a new password after the information processing apparatus has been attached to the attachment target. For example, security robustness can be improved by either setting a common password shared among other information processing apparatuses or setting no password until the information processing apparatus is attached to the attachment target, and by setting an individual password after the information processing apparatus has been attached to the attachment target. Accordingly, the information processing apparatus that offers a high degree of security robustness can be achieved.

With the information processing method according to the present invention, data is stored in the storage. When a password has been set, the password is stored in the storage. If an entered password matches the password stored in the storage, at least one of processing for reading the data and processing for writing the data is performed on the storage. It is determined whether or not an information processing apparatus including the storage has been attached to an attachment target. When it is determined that the information processing apparatus has been attached to the attachment target and if the password is stored in the storage, the password stored in the storage is changed. If the password is not stored in the storage, a new password is stored and set in the storage. Accordingly, it is possible to either set another password different from the password before attachment or set a new password after the information processing apparatus has been attached to the attachment target. For example, security robustness can be improved by either setting a common password shared among other information processing apparatuses or setting no password until the information processing apparatus is attached to the attachment target, and by setting an individual password after the information processing apparatus has been attached to the attachment target. Accordingly, the information processing apparatus that offers a high degree of security robustness can be achieved.

The object, features, forms, and advantages of the present invention will become more apparent from the following detailed description and the accompanying drawings.

### BRIEF DESCRIPTION OF DRAWINGS

FIG. 1 is a block diagram illustrating a configuration of an information processing apparatus 1 according to a first embodiment of the present invention.

FIG. 2 is a block diagram illustrating a configuration of an information processing apparatus 2 according to a second embodiment of the present invention.

FIG. 3 is a block diagram illustrating one example of a hardware configuration of the information processing apparatus 2 according to the second embodiment of the present invention.

FIG. 4 is a block diagram illustrating the hardware configuration of the information processing apparatus 2 in which a processing circuit 50 is configured using a processor.

FIG. 5 is a flowchart illustrating a processing procedure of password management processing performed by the information processing apparatus 2 according to the second embodiment of the present invention.

FIG. 6 illustrates one example of a sequence of the password management processing.

FIG. 7 is a block diagram illustrating a configuration of an information processing apparatus 2A according to a third embodiment of the present invention.

FIG. 8 is a flowchart illustrating a processing procedure of password management processing performed by the information processing apparatus 2A according to the third embodiment of the present invention.

FIG. 9 is a block diagram illustrating a configuration of an information processing apparatus 100 according to a fourth embodiment of the present invention.

### DESCRIPTION OF EMBODIMENTS

### First Embodiment

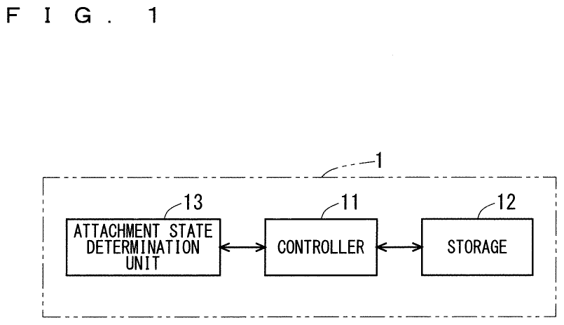

FIG. 1 is a block diagram illustrating a configuration of an information processing apparatus 1 according to a first embodiment of the present invention. The information processing apparatus 1 includes a controller 11, a storage 12, and an attachment state determination unit 13. The information processing apparatus 1 is, for example, mounted and used in a movable unit such as a vehicle. For example, the information processing apparatus 1 is provided in a navigation device and mounted on a movable unit. An information processing method according to another embodiment of the present invention is executed by the information processing apparatus 1 according to the present embodiment.

The storage 12 stores data. When a password has been set in the storage 12, the storage 12 stores the set password. When a password has been set in the storage 12 and if an entered password matches the password stored in the storage 12, the controller 11 performs at least one of data reading processing and data writing processing on the storage 12.

The password stored in the storage 12 is a common password shared among the storages 12 of other information processing apparatuses 1 until the information processing apparatus 1 is attached to an attachment target. This takes into consideration of, for example, convenience in updating data in manufacturing lines and oversea warehouses. Alternatively, no password may be set in the storage 12 until the information processing apparatus 1 is attached to the attachment target. For example, in the case where the information processing apparatus 1 is located in an environment where there is no risk of information leakage from the storage 12, such as where the information processing apparatus 1 is in a manufacturing line, there is no need to set a password in the storage 12 until the information processing apparatus 1 is attached to the attachment target.

In the case of using a common password as the password of the storage 12 among a plurality of information processing apparatuses 1 as described above, password leakage from the storage 12 of one information processing apparatus 1 can result in leakage of information stored in the storages 12 of all the information processing apparatuses 1. In view of this, the present embodiment describes changing the password of the storage 12 from a common password shared among other information processing apparatuses 1 to an individual password set for each information processing apparatus 1 after the information processing apparatus 1 has been attached to the attachment target. Also, in the case where, as described above, no password is set in the storage 12 before the information processing apparatus 1 is attached to the attachment target, a new password is stored and set in the storage 12 after the information processing apparatus 1 has been attached to the attachment target.

The attachment state determination unit 13 determines whether this apparatus, i.e., the information processing apparatus 1, has been attached to the attachment target. The attachment target is, for example, the aforementioned movable unit such as a vehicle. In the case where the attachment state determination unit 13 determines that this apparatus, i.e., the information processing apparatus 1, has been attached to the attachment target, if a password is stored in the storage 12, the controller 11 changes the password stored in the storage 12. If no password is stored in the storage 12, the controller 11 stores and sets a new password in the storage 12.

The controller 11 can generate an individual password by storing a plurality of numbers, characters, and symbols in advance in a memory (not shown) and combining them randomly, or can generate an individual password by storing a plurality of passwords in advance in a memory (not shown) and selecting one of the passwords.

The controller 11 includes a memory not shown and stores lock-state information indicating the lock state of the storage 12 in the memory. The lock-state information includes information indicating whether or not the storage 12 is locked, and if the storage is locked, also includes information indicating the password with which the storage 12 is locked. Here, “locked” refers to, when a password has been set in the storage 12 and if the entered password does not match the set password, locking the storage 12 in order to prevent the aforementioned processing from being performed on the storage 12, or to the locked state of the storage 12. After having changed the password of the storage 12 or having set a new password, the controller 11 updates the lock-state information on the storage 12 stored in the memory.

For example, there are cases in which, after the information processing apparatus 1 has been attached to the attachment target, an engineer performs data reading and writing processing on the storage 12 of the information processing apparatus 1 for maintenance or other purposes. In this case, the apparatus operated by the engineer acquires the lock-state information on the storage 12 stored in the memory (not shown) of the controller 11, obtains the password of the storage 12 from the acquired lock-state information, and performs data reading and writing processing on the storage 12 by using the obtained password.

Alternatively, in the case where, as described above, the individual password is generated by selecting one of a plurality of passwords stored in advance, the following operations may be performed. Specifically, the engineer or the apparatus operated by the engineer is notified of a plurality of passwords stored in advance, and then the engineer operates the apparatus to sequentially select and input one of the plurality of passwords as the password of the storage 12. In this way, the engineer may unlock the storage 12 and perform data reading and writing processing on the storage 12.

As described above, according to the present embodiment, the information processing apparatus 1 is configured to include the controller 11, the storage 12, and the attachment state determination unit 13. The storage 12 stores data. When a password has been set, the storage 12 stores the password. If the entered password matches the password stored in the storage 12, the controller 11 performs at least one of data reading processing and data writing processing on the storage 12.

According to the present embodiment, the attachment state determination unit 13 determines whether or not the information processing apparatus 1 has been attached to the attachment target. In the case where the attachment state determination unit 13 determines that the information processing apparatus 1 has been attached to the attachment target, if a password is stored in the storage 12, the controller 11 changes the password stored in the storage 12. If no password is not stored in the storage 12, the controller 11 stores and sets a new password in the storage 12.

In this way, after the information processing apparatus 1 has been attached to the attachment target, it is possible to either set another password different from the password before attachment or set a new password. For example, security robustness can be improved by either setting a common password shared among other information processing apparatuses or setting no password until the information processing apparatus 1 is attached to the attachment target, and by setting an individual password after the information processing apparatus 1 has been attached to the attachment target. Accordingly, the information processing apparatus 1 that offers a high degree of security robustness can be achieved.

### Second Embodiment

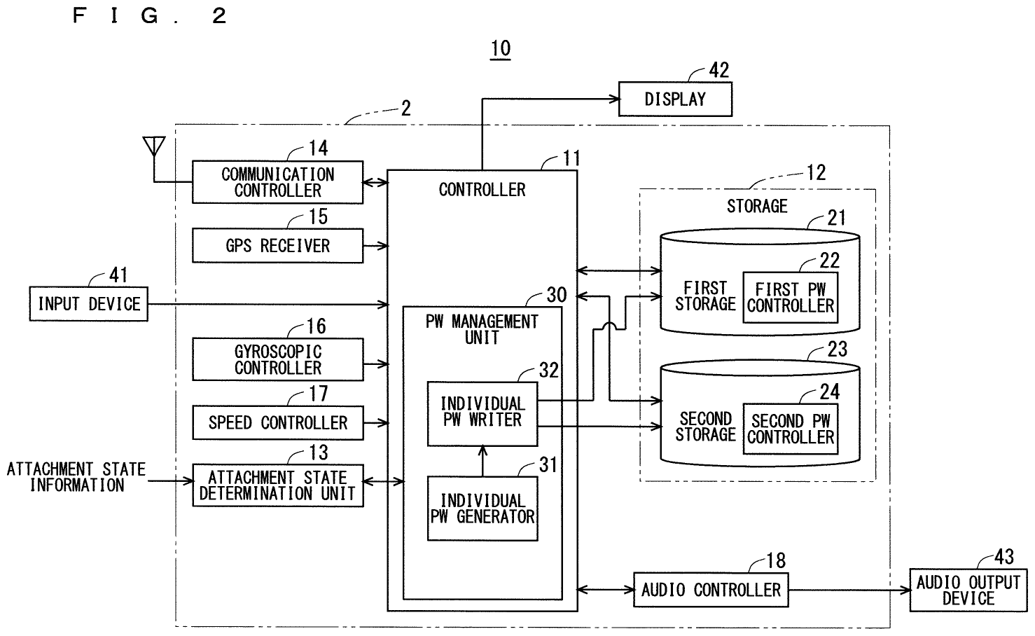

FIG. 2 is a block diagram illustrating a configuration of an information processing apparatus 2 according to a second embodiment of the present invention. The information processing apparatus 2 according to the present embodiment includes the same configuration as that of the information processing apparatus 1 according to the aforementioned first embodiment illustrated in FIG. 1. Thus, the same reference numerals have been given to constituent elements that are the same, and common description thereof will not be given. An information processing method according to another embodiment of the present invention is executed by the information processing apparatus 2 according to the present embodiment.

The information processing apparatus 2 is, for example, mounted and used in a movable unit such as a vehicle. The information processing apparatus 2 is provided in an information providing device 10 and mounted on a movable unit. In the present embodiment, the movable unit is a vehicle, and the information processing apparatus 2 is provided in the information providing device 10 and mounted on a vehicle. In the present embodiment, the information providing device 10 is implemented by a navigation device having a navigation function of guiding routes.

The information processing apparatus 2 constitutes the information providing device 10, together with an input device 41, a display 42, and an audio output device 43. That is, the information providing device 10 includes the information processing apparatus 2, the input device 41, the display 42, and the audio output device 43.

The information processing apparatus 2 includes a controller 11, a storage 12, an attachment state determination unit 13, a communication controller 14, a global positioning system (GPS) receiver 15, a gyroscopic controller 16, a speed controller 17, and an audio controller 18.

The controller 11 is configured by, for example, a central processing unit (CPU for short) and a memory such as a writable random access memory (RAM). The memory stores control programs. The functions of the attachment state determination unit 13, the communication controller 14, the GPS receiver 15, the gyroscopic controller 16, the speed controller 17, and the audio controller 18, which constitute the information processing apparatus 2, are implemented by the CPU executing the control programs stored in the memory.

The controller 11 performs overall control of the information processing apparatus 2. In the present embodiment, the controller 11 performs overall control of the information providing device 10 including the information processing apparatus 2. The controller 11 also controls the display 42.

The controller 11 includes a password (PW for short) management unit 30. The PW management unit 30 includes an individual PW generator 31 and an individual PW writer 32. In order to prevent unauthorized reading and writing of data from and to the storage 12, a password is set in the storage 12. The PW management unit 30 manages the password set in the storage 12.

In the present embodiment, either a common password shared among other information processing apparatuses (hereinafter, referred to as a “common password”) is set as the password of the storage 12, or no password is set in the storage 12 until the information processing apparatus 2 is attached to the attachment target. When the information processing apparatus 2 has been attached to the attachment target, an individual password set for each individual information processing apparatus 2 (hereinafter, also referred to as an “individual password”) is set as the password of the storage 12.

The individual PW generator 31 generates an individual password that is set individually for each information processing apparatus 2 as the password of the storage 12. The individual PW generator 31 can generate an individual password by storing a plurality of numbers, characters, and symbols in advance and combining them randomly, or can generate an individual password by storing a plurality of passwords in advance and selecting one of the passwords.

The individual PW generator 31 gives the generated individual password to the individual PW writer 32. The individual PW writer 32 writes the individual password generated by the individual PW generator 31 to the storage 12 and set that password as the password of the storage 12.

The individual password is generated in one-to-one correspondence with each information processing apparatus 2 as a password inherent to the information processing apparatus 2. Thus, for example in the case where the information processing apparatus 2 that has been attached to the attachment target and for which the individual password has been set is detached from the attachment target and another information processing apparatus 2 is newly attached to the attachment target, another individual password different from that stored in the storage 12 of the initially attached information processing apparatus 2 is generated and set in the storage 12 of the other information processing apparatus 2.

After having generated the individual password, the individual PW generator 31 generates information indicating that the individual password has already been generated, as generation-state information that is information indicating whether or not the individual password has been generated. The individual PW generator 31 stores the generated generation-state information in the memory (not shown) of the controller 11.

The storage 12 includes a first storage 21 and a second storage 23. The first storage 21 includes a first PW controller 22. The second storage 23 includes a second PW controller 24.

The first storage 21 is implemented by, for example, a storage device such as a semiconductor memory. The semiconductor memory is, for example, a storage device used by sticking an SD memory card to a board, such as an embedded secure digital (eSD) memory card. The eSD memory card is a device having a password protection function based on SD standards (SD Association guidelines).

The first PW controller 22 stores the password set in the first storage 21. The first PW controller 22 determines whether or not the entered password matches the stored password, and if they match, controls the first storage 21 so as to enable data writing and reading operations that are performed on the first storage 21.

The second storage 23 is implemented by, for example, a storage device such as a hard disk drive (HDD for short) device or a solid state drive (SSD) device. The HDD device and the SSD device are devices having a password protection function based on ATA standards (ANSI).

The second PW controller 24 stores the password set in the second storage 23. The second PW controller 24 determines whether or not the entered password matches the stored password, and if they match, controls the second storage 23 so as to enable data reading and writing operations that are performed on the second storage 23.

The attachment state determination unit 13 acquires attachment state information indicating whether or not the information processing apparatus 2 has been attached to the attachment target and determines, on the basis of the acquired attachment state information, whether or not the information processing apparatus 2 has been attached to the attachment target. In the present embodiment, the attachment target is a movable unit, and more specifically, a vehicle.

The attachment state information is given from the outside of the information processing apparatus 2, e.g., from a vehicle via a controller area network (CAN) mounted on the vehicle. The CAN corresponds to standards for use in data communication between vehicles. The attachment state information is, for example, information indicating whether a personal identification number (PIN) code is valid or invalid.

When the information processing apparatus 2 has been attached to the attachment target, the PIN code is made invalid because the information processing apparatus 2 can be identified from identification information on the attachment target to which the information processing apparatus 2 has been attached. Thus, if the attachment state information indicates that the PIN code is invalid, the attachment state determination unit 13 determines that the information processing apparatus 2 has been attached to the attachment target. If the attachment state information indicates that the PIN code is valid, the attachment state determination unit 13 determines that the information processing apparatus 2 is not attached to the attachment target.

The attachment state information is not limited to the information indicating whether or not the PIN code is valid or invalid. For example, other information such as speed information indicating the travelling speed of the vehicle such as a vehicle speed pulse, angular speed information indicating the angular speed of the vehicle, or steering angle information indicating the steering angle may be used as the attachment state information.

For example, in the case of using the speed information as the attachment state information, the attachment state determination unit 13 determines that the information processing apparatus 2 has been attached to the attachment target if the speed information indicates that the travelling speed of the vehicle is not zero. If the speed information indicates that the travelling speed of the vehicle is zero, the attachment state determination unit 13 determines that the information processing apparatus 2 is not attached to the attachment target.

Also, for example in the case of using the angular speed information as the attachment state information, the attachment state determination unit 13 determines that the information processing apparatus 2 has been attached to the attachment target if the angular speed information indicates that the angular speed of the vehicle is not zero. If the angular speed information indicates that the angular speed of the vehicle is zero, the attachment state determination unit 13 determines that the information processing apparatus 2 is not attached to the attachment target.

Also, for example in the case of using the steering angle information as the attachment state information, the attachment state determination unit 13 determines that the information processing apparatus 2 has been attached to the attachment target if the steering angle information indicates that the steering angle is not zero. If the steering angle information indicates that the steering angle is zero, the attachment state determination unit 13 determines that the information processing apparatus 2 is not attached to the attachment target.

The communication controller 14 controls communication between the information processing apparatus 2 and an external device, e.g., an external server device. The communication controller 14 transmits a signal received from the controller 11 to the external device via an antenna. The communication controller 14 also receives a signal transmitted from the external device and gives the received signal to the controller 11.

The GPS receiver 15 receives a radio signal (hereinafter, also referred to as a “GPS signal”) from a GPS satellite. The GPS receiver 15 gives the received GPS signal to the controller 11. The controller 11 calculates the current location of the information processing apparatus 2 on the basis of the GPS signal received from the GPS receiver 15. The current location of the information processing apparatus 2 corresponds to the current location of the vehicle on which the information processing apparatus 2 is mounted. The controller 11 generates current location information indicating the calculated current location.

The gyroscopic controller 16 gives angular speed information received from the vehicle to the controller 11. The speed controller 17 gives speed information received from the vehicle to the controller 11.

The controller 11 performs arithmetic processing using the GPS signal received from the GPS receiver 15, the angular speed information received from the gyroscopic controller 16, the speed information received from the speed controller 17, and the data stored in the first storage 21 and the second storage 23. On the basis of the result of the arithmetic processing, the controller 11 causes the display 42 to display the current location and route of the vehicle for navigation.

The input device 41 includes an operation input unit (not shown) operated by a user. The operation input unit includes, for example, operation switches and operation buttons. The input device 41 is used when a user inputs various types of information such as numeric information, character information, and information on instructions given to the information processing apparatus 2. When the operation input unit is operated by the user, the input device 41 generates operation information in accordance with the user's input operation and gives the generated operation information to the controller 11.

Instead of the operation switches and the operation buttons, the operation input unit of the input device 41 may be configured by a touch panel or an audio input device that enables audio operation input.

In the case where the operation input unit of the input device 41 is configured by a touch panel, the touch panel is installed on the display screen of the display 42 and detects a user's touch operation and touched position. The touch panel generates operation information in accordance with the detected touch operation and touched position and gives the generated operation information to the controller 11.

In the case where the operation input unit of the input device 41 is configured by an audio input device, the audio input device recognizes input audio. The audio input device generates operation information in accordance with the recognized audio and gives the generated operation information to the controller 11.

The controller 11 controls the information processing apparatus 2 on the basis of the operation information received from the input device 41. The operation information is information indicating the target and contents of the operation. The operation information includes, for example, at least one of pieces of information indicating the type of the operation, the number of times the operation has been performed, the length of time of the operation, the image targeted for the operation and the display area of the image, the amount of information displayed, the display position, the display processing load, and the position or area of the operation in the display screen of the display 42.

The display 42 is implemented by, for example, a liquid crystal display. The display 42 displays an image indicated by a video signal received from the controller 11 on the display screen in accordance with an instruction received from the controller 11. Through this, the display can provide various types of information to the user of the information providing device 10.

The audio controller 18 controls the audio output device 43. The audio controller 18 controls the audio output device 43 so as to, for example, reproduce audio files stored in the storage 12. The audio output device 43 is implemented by, for example, a speaker.

In the present embodiment, the attachment state determination unit 13 acquires the attachment state information and determines, on the basis of the acquired attachment state information, whether or not the information processing apparatus 2 has been attached to a vehicle, which is the attachment target. The acquisition of the attachment state information and the determination as to whether or not the information processing apparatus 2 has been attached are performed when, for example, the information providing device 10 including the information processing apparatus 2 has been started up.

When the attachment state determination unit 13 determines that the information processing apparatus has been attached to the vehicle, the PW management unit 30 that manages the password of the storage 12 causes the individual PW generator 31 to generate an individual password. The PW management unit 30 causes the individual PW writer 32 to write the generated individual password to the first storage 21 and second storage 23 of the storage 12.

Accordingly, if a common password is stored in the first storage 21 and the second storage 23, the common password stored in the first storage 21 and the second storage 23 is overwritten with the individual password to set the individual password in the first storage 21 and the second storage 23. If no password is stored in the first storage 21 and the second storage 23, a new individual password is set in each of the first storage 21 and the second storage 23. This helps improving the level of security.

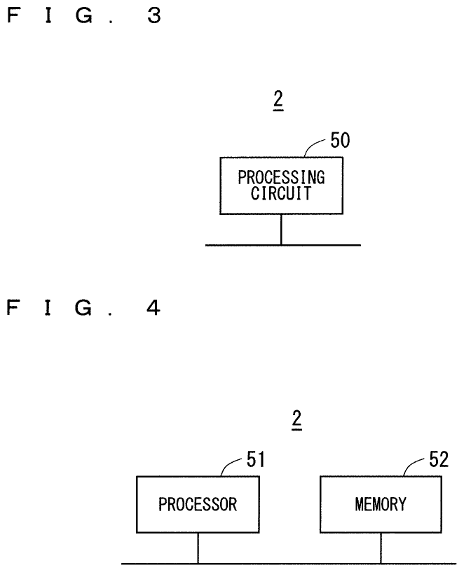

FIG. 3 is a block diagram illustrating one example of a hardware configuration of the information processing apparatus 2 according to the second embodiment of the present invention. Each element of the information processing apparatus 2 illustrated in FIG. 2, and more specifically, the controller 11 and the attachment state determination unit 13, are implemented by, for example, a processing circuit 50 illustrated in FIG. 3.

That is, the processing circuit 50 includes the attachment state determination unit 13 and the controller 11. The attachment state determination unit 13 determines whether or not the information processing apparatus 2 has been attached to the attachment target. The controller 11 performs at least one of data reading processing and data writing processing on the storage 12 when a password has been set and if the entered password matches the password stored in the storage 12. In the case where the attachment state determination unit 13 determines that the information processing apparatus 2 has been attached to the attachment target, if the password is stored in the storage 12, the controller 11 changes the password stored in the storage 12. If the password is not stored in the storage 12, the controller 11 sets and stores a new password in the storage 12.

As the processing circuit 50, dedicated hardware may be applied, or a processor for executing programs stored in the memory may be applied. The processor is, in some cases, called a microphone processor, a microphone computer, a central processing unit (CPU), an arithmetic unit, or a digital signal processor (DSP).

In the case where the processing circuit 50 is dedicated hardware, the processing circuit 50 corresponds to, for example, any processing circuit such as a single circuit, a composite circuit, a programmed processor, a parallel-programmed processor, an application specific integrated circuit (ASIC), a field programmable gate array (FPGA), or a circuit that combines these. The functions of the elements of the information processing apparatus 2 may be implemented by a plurality of processing circuits, or these functions may be implemented all together by a single processing circuit.

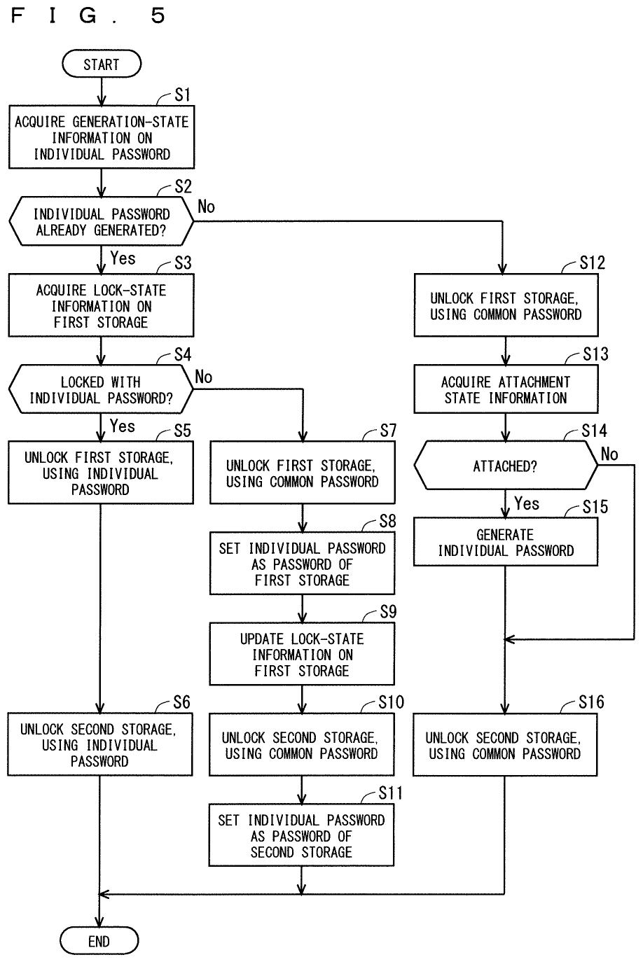

FIG. 4 is a block diagram illustrating a hardware configuration of the information processing apparatus 2 when the processing circuit 50 is configured as a processor. As illustrated in FIG. 4, the information processing apparatus 2 includes a processor 51 and a memory 52. In this case, the function of each element of the information processing apparatus 2 is implemented by software, firmware, or a combination of software and firmware. Software, firmware, or a combination of software and firmware is described as programs and stored in the memory 52.

The processor 51 serving as the processing circuit 50 implements the function of each unit by reading out and executing the programs stored in the memory 52. That is, the information processing apparatus 2 includes the memory 52 for storing programs that, when executed by the processing circuit 50, cause the following processing to be eventually performed. The following processing includes processing for, when a password has been set and if the entered password matches the password stored in the storage 12, performing at least one of data reading processing and data writing processing on the storage 12; processing for determining whether or not the information processing apparatus 2 has been attached to the attachment target; and processing for, when the attachment state determination unit 13 determines that the information processing apparatus 2 has been attached to the attachment target, changing the password stored in the storage 12 if the password is stored in the storage 12, and storing and setting a new password in the storage 12 if the password is not stored in the storage 12. In other words, these programs are also called programs that cause a computer to execute a procedure and method of operations of each element of the information processing apparatus 2.

Here, the memory 52 corresponds to, for example, any storage medium such as a semiconductor memory, a magnetic disk, a flexible disk, an optical disk, a compact disc, a minidisk, or a digital versatile disc (DVD). The aforementioned semiconductor memory corresponds to, for example, any non-volatile or volatile semiconductor memory such as a random access memory (RAM), a read-only memory (ROM), a flash memory, an erasable programmable read-only memory (EPROM), or an electrically erasable programmable read-only memory (EEPROM).

As described above, the present embodiment describes a configuration in which the function of each element of the information processing apparatus 2 is implemented by one of hardware, software, and so on. The present invention is, however, not limited to this configuration, and a configuration is also possible in which some elements of the information processing apparatus 2 are implemented by dedicated hardware, and other some elements are implemented by, for example, software. For example, the functions of some elements may be implemented by the processing circuit 50 serving as dedicated hardware, and the functions of other some elements may be implemented by the processing circuit 50 serving as the processor 51 and reading out and executing programs stored in the memory 52.

As described above, the information processing apparatus 2 can implement each of the aforementioned functions by, for example, hardware, software, or a combination of these.

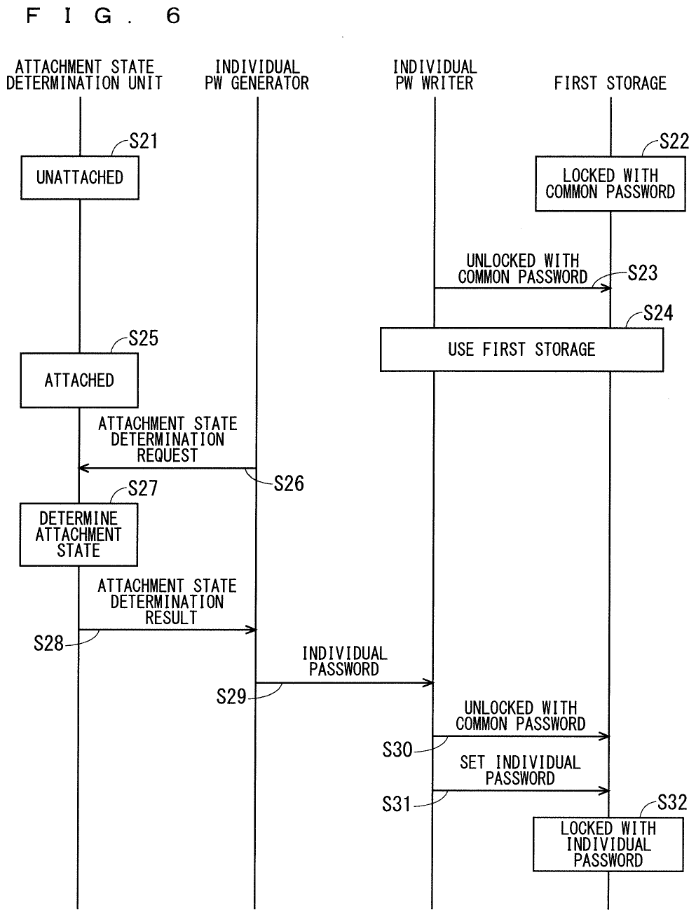

FIG. 5 is a flowchart illustrating a processing procedure of password management processing performed by the information processing apparatus 2 according to the second embodiment of the present invention. FIG. 5 illustrates the processing procedure performed when a common password has been set in the first storage 21 and the second storage 23 before the information processing apparatus 2 is attached to the attachment target. Steps in the flowchart illustrated in FIG. 5 are executed by the controller 11 and the attachment state determination unit 13 that constitute the information processing apparatus 2 and by the individual PW generator 31 and individual PW writer 32 of the PW management unit 30 of the controller 11. The processing in the flowchart illustrated in FIG. 5 starts upon power-on of the information providing device 10 including the information processing apparatus 2, and the procedure moves to step S1.

In step S1, the individual PW generator 31 of the PW management unit 30 of the controller 11 acquires generation-state information on the individual password from the memory (not shown) of the controller 11. The individual password generation-state information is information indicating whether or not the individual password has been generated. When the individual password generation-state information has been acquired, the procedure moves to step S2.

In step S2, the individual PW generator 31 determines, on the basis of the acquired generation-state information, whether or not the individual password has been generated. If it is determined that the individual password has been generated, the procedure moves to step S3, and if it is determined that the individual password is not generated, the procedure moves to step S12. Thus, in the case where processing is first performed after the information processing apparatus 2 has been mounted on a vehicle, the procedure moves from step S2 to step S12.

In step S3, the controller 11 acquires lock-state information on the first storage 21 from the first PW controller 22 of the first storage 21. The lock-state information on the first storage 21 includes information indicating whether or not the first storage 21 is locked and also includes, if the storage is locked, information indicating the password with which the storage is locked.

When the first storage 21 has been locked, the first PW controller 22 generates the lock-state information on the first storage 21 and stores the information in the memory (not shown). When an instruction to transmit the lock-state information has been received from the controller 11 of the information processing apparatus 2, the first PW controller 22 reads out the lock-state information from the memory (not shown) and transmits this information to the controller 11. In this way, the controller 11 acquires the lock-state information on the first storage 21. When the lock-state information on the first storage 21 has been acquired, the procedure moves to step S4.

In step S4, the controller 11 determines, on the basis of the acquired lock-state information, whether or not the first storage 21 is locked with the individual password. If it is determined that the storage is locked with the individual password, the procedure moves to step S5, and if it is determined that the storage is not locked with the individual password, the procedure moves to step S7.

In step S5, the controller 11 unlocks the first storage 21, using the individual password. When the first storage 21 has been unlocked, the procedure moves to step S6.

In step S6, the controller 11 unlocks the second storage 23, using the individual password. After the processing in step S6 has ended, the entire processing procedure ends.

If the procedure moves to step S7 after it is determined in step S4 described above that the first storage 21 is not locked with the individual password, in step S7, the controller 11 unlocks the first storage 21, using a common password shared among other information processing apparatuses 2. When the first storage 21 has been unlocked, the procedure moves to step S8.

In step S8, the controller 11 causes the individual PW writer 32 of the PW management unit 30 to set the individual password generated by the individual PW generator 31 as the password of the first storage 21.

Specifically, the individual PW writer 32 writes the individual password generated by the individual PW generator 31 to the first storage 21 and instructs the first PW controller 22 to set the individual password as the password of the first storage 21. In accordance with the instruction from the individual PW writer 32, the first PW controller 22 sets the individual password written by the individual PW writer 32 as the password of the first storage 21. When the individual password has been set in this way, the procedure moves to step S9.

In step S9, the controller 11 updates the lock-state information on the first storage 21. Here, the lock-state information on the first storage 21 is updated so as to include information indicating that the first storage 21 is locked with the individual password. When the lock-state information has been updated, the procedure moves to step S10.

In step S10, the controller 11 unlocks the second storage 23, using the common password. When the second storage 23 has been unlocked, the procedure moves to step S11.

In step S11, the controller 11 causes the individual PW writer 32 of the PW management unit 30 to set the individual password generated by the individual PW generator 31 as the password of the second storage 23 in the same manner as in step S8 described above.

Specifically, the individual PW writer 32 writes the individual password generated by the individual PW generator 31 to the second storage 23 and instructs the second PW controller 24 to set the individual password as the password of the second storage 23. In accordance with the instruction from the individual PW writer 32, the second PW controller 24 sets the individual password written by the individual PW writer 32 as the password of the second storage 23.

After the individual password has been set in this way and the processing in step S11 has ended, the entire processing procedure ends.

If the procedure moves to step S12 after it is determined in step S2 described above that the individual password has not been generated, in step S12, the controller 11 unlocks the first storage 21, using the common password. When the first storage 21 has been unlocked, the procedure moves to step S13.

In step S13, the attachment state determination unit 13 acquires the attachment state information from the vehicle via a CAN. When the attachment state information has been acquired, the procedure moves to step S14.

In step S14, the attachment state determination unit 13 determines, on the basis of the acquired attachment state information, whether or not the information processing apparatus 2 is attached to the attachment target. If it is determined that the information processing apparatus is attached, the procedure moves to step S15, and if it is determined that the information processing apparatus is not attached, the procedure moves to step S16.

In step S15, the individual PW generator 31 generates an individual password. When the individual password has been generated, the procedure moves to step S16.

In step S16, the controller 11 unlocks the second storage 23, using the common password. After the processing in step S16 has ended, the entire processing procedure ends.

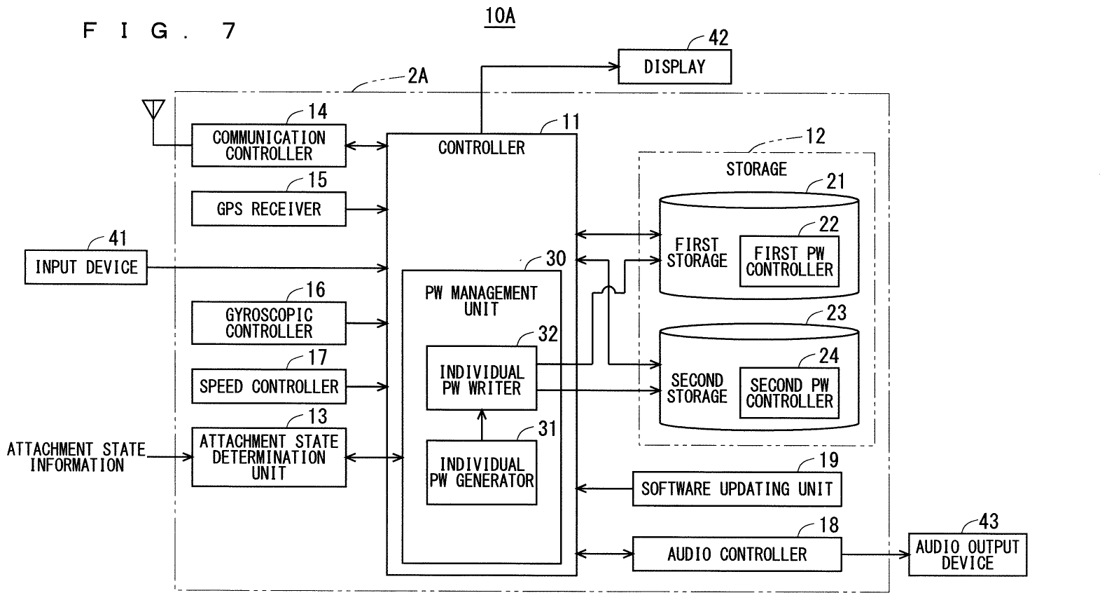

FIG. 6 illustrates one example of a sequence of the password management processing. FIG. 6 illustrates the sequence performed when a common password has been set in the first storage 21 and the second storage 23 before the information processing apparatus 2 is attached to the attachment target. In step S21, the information processing apparatus 2 is not attached to a vehicle that is the attachment target, i.e., in an unattached state.

In step S22, the first storage 21 is in a locked state using a common password, i.e., it is locked with a common password set as the password.

In step S23, the individual PW writer 32 unlocks the first storage 21, using the common password. Specifically, the individual PW writer 32 uses the common password to unlock the first storage 21.

When the first storage 21 has been unlocked in this way, the information processing apparatus 2 uses the first storage 21 in step S24. Specifically, the controller 11 performs at least one of data reading processing and data writing processing on the first storage 21.

In step S25, the information processing apparatus 2 is attached to the vehicle that is the attachment target, i.e., in an attached state.

In step S26, the individual PW generator 31 transmits an attachment state determination request that requests the attachment state determination unit 13 to determine the attachment state of the information processing apparatus 2.

In step S27, the attachment state determination unit 13 determines the attachment state of the information processing apparatus 2 in accordance with the attachment state determination request received from the individual PW generator 31. Specifically, the attachment state determination unit 13 determines, on the basis of the attachment state information on the information processing apparatus 2 acquired from the outside, whether or not the information processing apparatus 2 has been attached to the vehicle, which is the attachment target.

In step S28, the attachment state determination unit 13 transmits to the individual PW generator 31 an attachment state determination result that is the result of determination of the attachment state of the information processing apparatus 2.

In step S29, the individual PW generator 31 gives the generated individual password to the individual PW writer 32.

In step S30, the individual PW writer 32 unlocks the first storage 21, using the common password. Specifically, the individual PW writer 32 uses the common password to unlock the first storage 21.

In step S31, the individual PW writer 32 sets the individual password in the first storage 21.

In step S32, the first storage 21 is in a locked state using the individual password, i.e., it is locked with the individual password set as the password.

While one example of the sequence of the password management processing performed on the first storage 21 is illustrated in FIG. 6, the password management processing is also performed on the second storage 23 in accordance with a sequence similar to that in FIG. 6.

When the first storage 21 and the second storage 23 have been unlocked as described above, the controller 11 performs at least one of data reading processing and data writing processing on the first storage 21 and the second storage 23. Detailed description of the data reading processing and the data writing processing will not be given.

As described above, according to the present embodiment, the attachment state determination unit 13 determines whether or not the information processing apparatus 2 has been attached to the vehicle, which is the attachment target. In the case where the attachment state determination unit 13 determines that the information processing apparatus 2 has been attached to the vehicle, if a password is stored in the storage 12, the controller 11 changes the password stored in the storage 12. If no password is stored in the storage 12, the controller 11 stores and sets a new password in the storage 12.

Specifically, the individual PW generator 31 of the PW management unit 30 generates an individual password. The generated individual password is written to the first storage 21 and the second storage 23 of the storage 12 by the individual PW writer 32 so as to change the password stored in the first storage 21 and the second storage 23 or to set a new password.

In this way, another password different from the password before attachment can be set or a new password can be set after the information processing apparatus 2 has been attached to the vehicle. For example, security robustness can be improved by either setting a common password shared among other information processing apparatuses or setting no password until the information processing apparatus 2 is attached to the vehicle, and by setting an individual password individually for each information processing apparatus 2 after the information processing apparatus 2 has been attached to the vehicle. Accordingly, the information processing apparatus 2 that offers a high degree of security robustness can be achieved.

According to the present embodiment, the attachment state determination unit 13 acquires, from outside the information processing apparatus, the attachment state information indicating whether or not the information processing apparatus has been attached to the attachment target and determines, on the basis of the acquired attachment state information, whether or not the information processing apparatus has been attached to the attachment target. Accordingly, the information processing apparatus 2 that offers a high degree of security robustness as described above can be achieved with a simpler structure.

### Third Embodiment

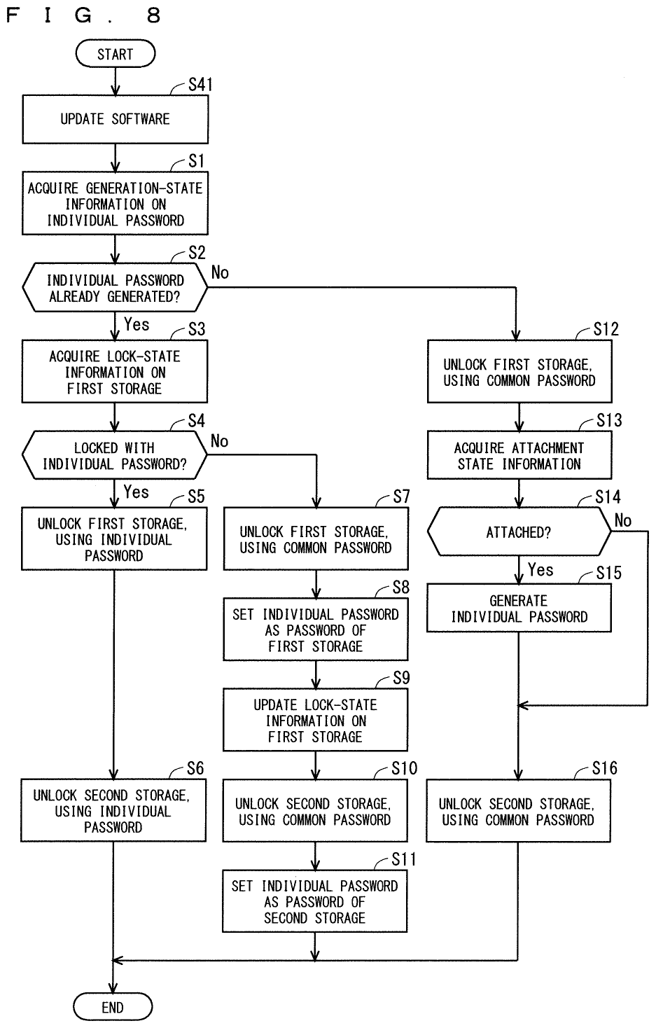

FIG. 7 is a block diagram illustrating a configuration of an information processing apparatus 2A according to a third embodiment of the present invention. The information processing apparatus 2A according to the present embodiment includes the same configuration as that of the information processing apparatus 2 according to the aforementioned second embodiment illustrated in FIG. 2. Thus, the same reference numerals have been given to constituent elements that are the same, and common description thereof will not be given. An information processing method according to another embodiment of the present invention is implemented by the information processing apparatus 2A according to the present embodiment.

Like the information processing apparatus 2 according to the aforementioned second embodiment, the information processing apparatus 2A is mounted and used in a movable unit such as a vehicle. The information processing apparatus 2A is provided in an information providing device 10A and mounted on a movable unit. In the present embodiment, the movable unit is a vehicle, and the information processing apparatus 2A is provided in the information providing device 10A and mounted on a vehicle. In the present embodiment, the information providing device 10A is implemented by a navigation device having a navigation function of guiding routes.

Like the information processing apparatus 2 according to the aforementioned second embodiment, the information processing apparatus 2A constitutes the information providing device 10A, together with the input device 41, the display 42, and the audio output device 43. That is, the information providing device 10A includes the information processing apparatus 2A, the input device 41, the display 42, and the audio output device 43.

The information processing apparatus 2A according to the present embodiment has a configuration in which the information processing apparatus 2 of the aforementioned second embodiment further includes a software updating unit 19. That is, the information processing apparatus 2A according to the present embodiment includes the controller 11, the storage 12, the attachment state determination unit 13, the communication controller 14, the GPS receiver 15, the gyroscopic controller 16, the speed controller 17, the audio controller 18, and the software updating unit 19.

The software updating unit 19 is an updating unit that acquires programs for implementing the functions of the controller 11 and the attachment state determination unit 13 and updates the function of the information processing apparatus, i.e., software executed by the information processing apparatus. The programs are acquired by downloading from an external device, e.g., a server device. The functions of the controller 11 and the attachment state determination unit 13 are implemented by executing the programs acquired by the software updating unit 19.

In the present embodiment, the software updating unit 19 downloads programs for executing the processing in the aforementioned flowchart illustrated in FIG. 5. For example, after the information providing device 10A including the information processing apparatus 2A has been shipped, the information processing apparatus 2A causes the software updating unit 19 to download programs for executing the password management processing in the aforementioned flowchart illustrated in FIG. 5. This allows even the information processing apparatus 2A after shipment of the information providing device 10A to execute the password management processing in the aforementioned flowchart illustrated in FIG. 5.

Accordingly, the information processing apparatus 2A that offers a high degree of security robustness as described above can be achieved easily.

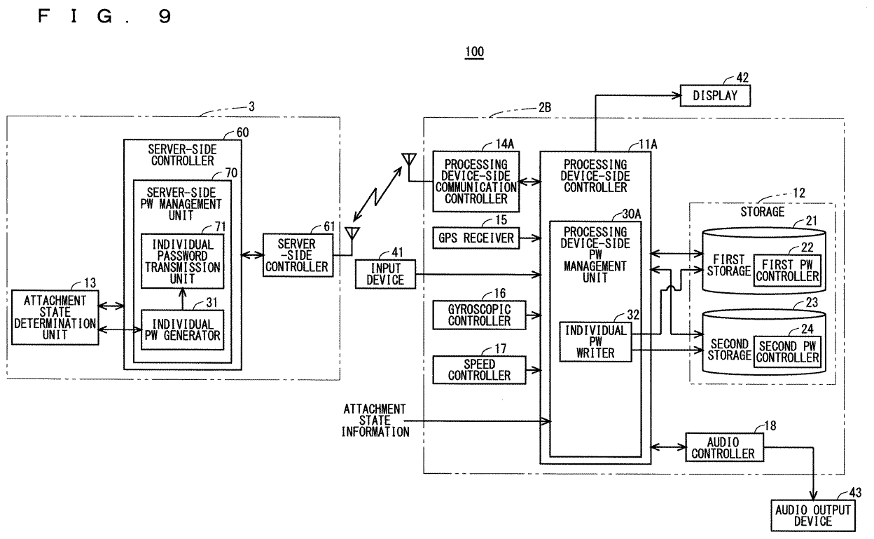

FIG. 8 is a flowchart illustrating a processing procedure of the password management processing performed by the information processing apparatus 2A according to the third embodiment of the present invention. The flowchart illustrated in FIG. 8 includes the same steps as those in the flowchart illustrated in FIG. 5. Thus, the same step numbers have been given to steps that are the same, and common description thereof will not be given. The steps in the flowchart illustrated in FIG. 8 are executed by the controller 11, the attachment state determination unit 13, and the software updating unit 19 that constitute the information processing apparatus 2A. The processing in the flowchart illustrated in FIG. 8 starts when an instruction to update software is input through the input device 41, and the procedure moves to step S41.

In step S41, the software updating unit 19 downloads programs as described above to update software to be executed by the information processing apparatus. When the software has been updated, the procedure moves to step S1. The processing in each of steps S1 to S16 is executed in the same manner as the password management processing according to the aforementioned second embodiment illustrated in FIG. 5.

As described above, according to the present embodiment, the software updating unit 19 acquires programs for executing the processing in the aforementioned flowchart illustrated in FIG. 5, i.e., programs for implementing the functions of the controller 11 and the attachment state determination unit 13, and updates the software to be executed by the information processing apparatus. The functions of the controller 11 and the attachment state determination unit 13 are implemented by executing the programs acquired by the software updating unit 19.

Accordingly, for example if the software updating unit 19 updates software after shipment of the information providing device 10A including the information processing apparatus 2A, even the information processing apparatus 2A after the shipment of the information providing device 10A can perform the password management processing in the aforementioned flowchart illustrated in FIG. 5. Accordingly, the information processing apparatus 2A that offers a high degree of security robustness as described above can be achieved easily.

The information processing apparatuses 1, 2, and 2A according to the above-described first to third embodiments are applicable not only to a navigation device that can be mounted on a vehicle, but also to a system that appropriately combines devices including a communication terminal device and a server device. Examples of the communication terminal device include a portable navigation device (PND) and a portable communication device that have a function of establishing communication with the server device. Examples of the portable communication device include a portable telephone, a smartphone, and a tablet terminal device.

In the case where a system is constructed by appropriately combining a navigation device, a communication terminal device, and a server device as described above, the constituent elements of the information processing apparatus 1, 2, or 2A are dispersed and disposed in each device that constitutes the system.

For example, the attachment state determination unit 13 and the individual PW generator 31 provided in the information processing apparatus 2 according to the aforementioned second embodiment may be disposed in the server device, or may be disposed in the communication terminal device such as a portable communication device.

The information processing apparatus when the attachment state determination unit 13 and the individual PW generator 31 are disposed in the server device as described above has, for example, a configuration described in the following fourth embodiment.

### Fourth Embodiment

FIG. 9 is a block diagram illustrating a configuration of an information processing apparatus 100 according to a fourth embodiment of the present invention. The information processing apparatus 100 according to the present embodiment is similar in configuration to the information processing apparatus 2 according to the aforementioned second embodiment. Thus, the same reference numerals have been given to constituent elements that are the same, and common description thereof will not be given.

The information processing apparatus 100 includes an information processing apparatus main unit 2B, the input device 41, the display 42, the audio output device 43, and a server device 3. The information processing apparatus main unit 2B is, for example, mounted and used in a movable unit such as a vehicle. In the present embodiment, the movable unit is a vehicle, and the information processing apparatus main unit 2B is mounted on a vehicle. In the present embodiment, a portion of the information processing apparatus 100 other than the server device 3 is implemented by a navigation device having a navigation function of guiding routes. That is, the information processing apparatus main unit 2B constitutes a navigation device, together with the input device 41, the display 42, and the audio output device 43.

The information processing apparatus main unit 2B includes a processing device-side controller 11A, the storage 12, a processing device-side communication controller 14A, the GPS receiver 15, the gyroscopic controller 16, the speed controller 17, and the audio controller 18. The processing device-side controller 11A, the processing device-side communication controller 14A, and a processing device-side PW management unit 30A are respectively configured like the controller 11, the communication controller 14, and the PW management unit 30 according to the second embodiment.

The server device 3 includes the attachment state determination unit 13, a server-side controller 60, and a server-side communication controller 61.

In the present embodiment, the attachment state information is information indicating the attachment state of the information processing apparatus main unit 2B. Upon acquiring the attachment state information, the processing device-side controller 11A of the information processing apparatus main unit 2B transmits the acquired attachment state information to the server device 3 via the processing device-side communication controller 14A. The server device 3 receives the attachment state information transmitted from the information processing apparatus main unit 2B via the server-side communication controller 61. The server-side communication controller 61 gives the received attachment state information to the attachment state determination unit 13 via the server-side controller 60.

In this way, the attachment state determination unit 13 acquires the attachment state information via the server-side controller 60, the server-side communication controller 61, the processing device-side communication controller 14A, and the processing device-side controller 11A. When it is determined, on the basis of the attachment state information, that the information processing apparatus main unit 2B has been attached to the attachment target, the attachment state determination unit 13 determines that the information processing apparatus 2 has been attached to an attachment target.

Like the controller 11 according to the aforementioned second embodiment, the server-side controller 60 is configured by, for example, a CPU and a writable memory such as a RAM. The memory stores control programs. The CPU performs centralized control of the attachment state determination unit 13 and the server-side communication controller 61 by executing control programs stored in the memory.

The server-side controller 60 includes a server-side PW management unit 70. The server-side PW management unit 70 includes the individual PW generator 31 and an individual PW transmission unit 71. The server-side PW management unit 70 and the server-side communication controller 61 are respectively configured like the PW management unit 30 and the communication controller 14 according to the aforementioned second embodiment. The individual PW transmission unit 71 transmits the individual password generated by the individual PW generator 31 to the information processing apparatus main unit 2B via the server-side communication controller 61.

The server-side communication controller 61 performs communication with the information processing apparatus main unit 2B, and more specifically, the processing device-side communication controller 14A of the information processing apparatus main unit 2B. In the case of communication with the information processing apparatus main unit 2B, the server-side communication controller 61 is configured to be capable of communication with the information processing apparatus main unit 2B via a communication network such as the Internet.

As described above, according to the present embodiment, the attachment state determination unit 13 and the individual PW generator 31 are disposed in the server device 3. Even with this arrangement, effects similar to those of the aforementioned first to third embodiments can be achieved.

Alternatively, the attachment state determination unit 13 and the individual PW generator 31 may be disposed in the communication terminal device such as a portable communication device as described above. Even if the attachment state determination unit 13 and the individual PW generator 31 are disposed in the communication terminal device, effects similar to those of the aforementioned first to third embodiments can be achieved.

Note that the present invention can freely combine each embodiment within the scope of the invention. Also, any constituent element of the embodiments can be appropriately changed or omitted.

While the present invention has been described in detail, the foregoing description is in all aspects illustrative and not restrictive. It is therefore to be understood that numerous modifications and variations can be devised without departing from the scope of the present invention.

### EXPLANATION OF REFERENCE SIGNS

1, 2, 2A, 100: information processing apparatus, 2B: information processing apparatus main unit, 3: server device, 10, 10A: information providing device, 11: controller, 11A: processing device-side controller, 12: storage, 13: attachment state determination unit, 14: communication controller, 14A: processing device-side communication controller, 15: GPS receiver, 16: gyroscopic controller, 17: speed controller, 18: audio controller, 19: software updating unit, 21: first storage, 22: first PW controller, 23: second storage, 24: second PW controller, 30: PW management unit, 31: individual PW generator, 32: individual PW writer, 30A: processing device-side PW management unit, 41: input device, 42: display, 43: audio output device, 60: server-side controller, 61: server-side communication controller, 70: server-side PW management unit, 71: individual PW transmission unit.

1. An information processing apparatus comprising:
a storage that stores data, and stores a password when the password has been set;
a controller that, when the password has been set and if an entered password matches the password stored in the storage, performs at least one of processing for reading the data and processing for writing the data on the storage; and
an attachment state determiner that determines whether or not the information processing apparatus has been attached to an attachment target,
wherein, in the case where the attachment state determiner determines that the information processing apparatus has been attached to the attachment target, if the password is stored in the storage, the controller changes the password stored in the storage, and if the password is not stored in the storage, the controller stores and sets a new password in the storage.

2. The information processing apparatus according to claim 1, wherein
the attachment state determiner acquires attachment state information indicating whether or not the information processing apparatus has been attached to the attachment target and determines, on the basis of the acquired attachment state information, whether or not the information processing apparatus has been attached to the attachment target.

3. The information processing apparatus according to claim 1, further comprising:
an updater that acquires a program for implementing functions of the controller and the attachment state determiner and updates a function of the information processing apparatus,
wherein the functions of the controller and the attachment state determiner are implemented by executing the program acquired by the updater.

4. An information processing method comprising:
storing data in a storage;
when a password has been set, storing the password in the storage, and if an entered password matches the password stored in the storage, performing at least one of processing for reading the data and processing for writing the data on the storage;
determining whether or not an information processing apparatus including the storage has been attached to an attachment target; and
in the case where it is determined that the information processing apparatus has been attached to the attachment target, changing the password stored in the storage if the password is stored in the storage, and storing and setting a new password in the storage if the password is not stored in the storage.
